(19) United States
(12) Patent Application Publication
(10) Pub. No.: US 2007/0094512 A1
(43) Pub. Date: Apr. 26, 2007

(54) Storage media issuing method

(76) Inventor: Masatsugu Nomiya, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/429,186

(22) Filed: May 8, 2006

(30) Foreign Application Priority Data
Oct. 26, 2005 (JP) 2005-310655

(51) Int. Cl. H04K 1/00

(52) U.S. Cl. 713/186

(57) ABSTRACT

A device needs to be created which can register biometric information by using an automated machine such as ATM and which can also verify an identity of a user. In this invention, a storage medium, which stores a decryption key and a decryption program for executing decryption processing using the decryption key, and an encryption key corresponding to the decryption key are sent to the user through separate routes. Biometric information of the user entered into the terminal device/ATM is encrypted with the encryption key that the user enters into the terminal device/ATM. The encrypted biometric information is sent to the IC card, and the storage medium decrypts the encrypted biometric information with the decryption key stored therein and stores the decrypted biometric information in itself.

### INCORPORATION BY REFERENCE

The present application claims priority from Japanese application JP2005-310655 filed on Oct. 26, 2005, the content of which is hereby incorporated by reference into this application.

### BACKGROUND OF THE INVENTION

The present invention relates to a technology to validate or issue storage media, including cash cards, credit cards and ID cards, so that they can receive a predetermined service. The storage media include magnetic cards and IC cards. Particularly the present invention also relates to a technology that verifies the identity of a card holder by using biometric information when he or she requests services. The present invention also relates to a technology to store information including biometric information in storage media.

There has been known a technology, as disclosed in JP-A-8-315223, that issues a cash card, one of storage media, with a simple procedure. In this conventional technology, when a customer applies for an issuance of a cash card, the following process is taken. At the site of application, the customer enters his or her password number or personal identification number into a PIN number input means at bank counters. The data entered is checked against the content of a customer data file and, if they agree, the input data is written into a card substrate and a card is issued.

### SUMMARY OF THE INVENTION

The above conventional technology, however, does not consider the security of the card. That is, if a third person of ill intention steals a personal identification number, this third person can pretend to be a legitimate user (customer), have a cash card issued and use it.

To counter this problem, this invention takes the following steps. (1) a storage medium, which stores decryption information and a decryption program for executing decryption processing using the decryption information, and (2) encryption information corresponding to the decryption information are sent to the user through different routes. Biometric information of the user entered into an issuance terminal is encrypted with the encryption information that the user enters into the issuance terminal. The encrypted biometric information is sent to the storage medium, and the storage medium decrypts the encrypted biometric information with the decryption information stored therein and stores the decrypted biometric information in itself. This makes it possible to issue a storage medium containing biometric information and used to receive services with a simple procedure (processing).

With this construction, if a third person should steal the encryption information, a storage medium cannot be issued because he or she does not have the storage medium storing the corresponding decryption information. If this third person has another storage medium, this storage medium holds a decryption key that does not match the stolen encryption key and thus cannot decrypt the encrypted biometric information and store it. Since the storage medium in question does not contain the (decrypted) biometric information, the user cannot be authenticated and not receive services using this storage medium. Further, if a storage medium containing decryption information is stolen or if encryption information is stolen, since the third person has no authorized decryption information, the (decrypted) biometric information cannot be stored in the storage medium. As a result, the third person cannot receive services using the storage medium.

The encryption information includes an encryption key and the decryption information includes a decryption key. These information need only be paired, i.e., match each other. For example, these information may perform a predetermined conversion or a reverse conversion on information including biometric information. Or they may be distributed information that is obtained by performing a secret sharing scheme on predetermined information. Or they may be prearranged information divided into two or more pieces. They may also be an ID and a password of the user. For information of this kind that cannot be easily identified as forming a pair, a check is made as follows. A table showing what pieces of information constitute a pair is stored in a card center (bank center) and used for a pair check when a card issuance terminal is used. That is, both of the paired information are sent from the issuance terminal and the card center checks if they form a pair. If it is decided that the two pieces of information form a pair, a permission is sent to the issuance terminal to write the biometric information into the storage medium. If there is biometric information to be written, it is written into the storage medium. This writing processing may be executed by the card issuance terminal. The pair may be made up of three or more pieces of information.

Further, the paired information may be given additional information that shows they form a pair. Further, a second storage medium may store information paired with the first storage medium and be sent to the user. Or both may be sent to the user through the network using separate emails. Further, this invention includes the use of other than biometric information. This may be user's identity information such as name and address, or a password the user can choose.

Furthermore, although a card is issued by using an issuance terminal, this invention includes processing of registering biometric information or others with a storage medium.

Other objects, features and advantages of the invention will become apparent from the following description of the embodiments of the invention taken in conjunction with the accompanying drawings.

### BRIEF DESCRIPTION OF THE DRAWINGS

FIG. 1 is an overall system configuration in one embodiment of this invention.

FIG. 2A illustrates a data table on a card issuance status in the embodiment.

FIG. 2B illustrates a data table (card company center) on a card issuance status in the embodiment.

FIG. 3A illustrates a data table on key information in the embodiment.

FIG. 3B illustrates a data table (card company center) on key information in the embodiment.

FIG. 4 is a flow chart showing processing before issuance in the embodiment.

FIG. 5 is a flow chart (part 1) showing issuance processing in the embodiment.

FIG. 6 is a flow chart (part 2) showing issuance processing in the embodiment.

FIG. 7 is a flow chart showing how an IC card is used in the embodiment.

FIG. 8 illustrates a concept of this invention.

FIG. 9 illustrates a configuration of each computer in the embodiment.

### DESCRIPTION OF THE INVENTION

One embodiment of this invention will be described by referring to the accompanying drawings. This embodiment takes up an example case of issuing an IC card from a terminal device such as an ATM (Automatic Teller Machine). It should be noted that the present invention is not limited to this application.

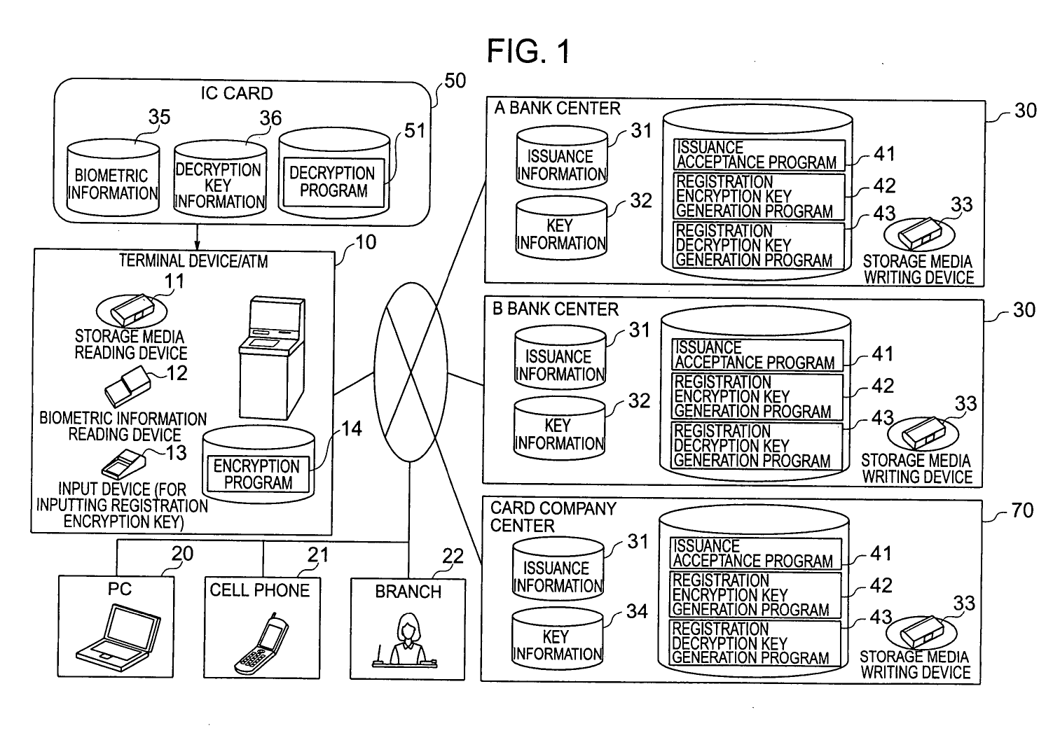

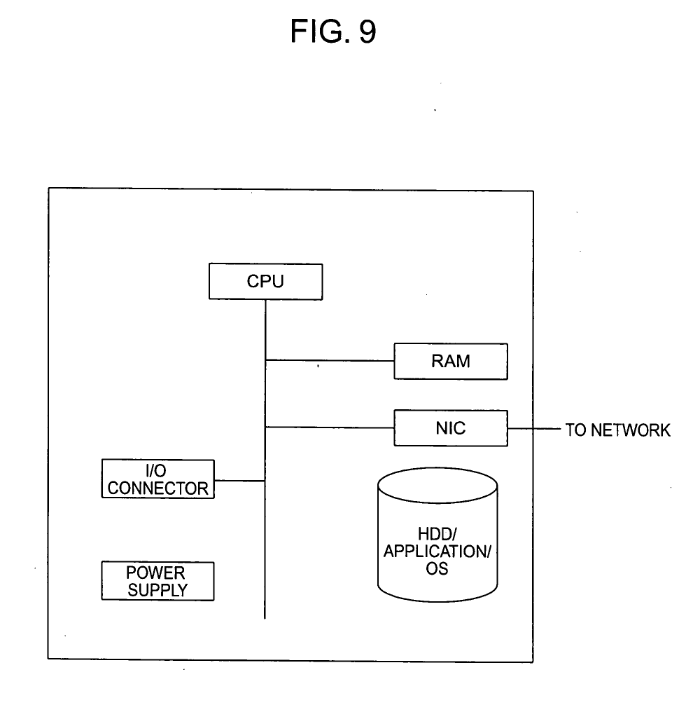

First, a system configuration of this embodiment is shown in FIG. 1 and FIG. 9. Computers are interconnected via networks. Each of the computers has storage devices such as memory and hard disk and a processing device such as CPU. According to a program stored in the storage device, the processing device processes information (FIG. 9). Constitutional elements of this system are as follows.

Designated 50 is an IC card to be issued which has an area 35 to store biometric information, an area 36 to store decryption key information used to decipher encrypted information, and an area 51 to store a decryption program. Denoted 10 is a terminal device/ATM (hereafter referred to as ATM 10) that issues an IC card 50. The ATM 10 has a storage media reading device 11 to write and read information to and from the IC card 50, a biometric information reading device 12 to read biometric information including finger vein information, and an input device 13 to receive information from the user. The input device 13 may be a touch panel and also accept an amount of money to be transacted. The biometric information reading device 12 may be constructed dismountable. Or it may be purchased independently and retrofitted to the ordinary ATM 10.

Next, denoted 20 is a personal computer and 21 a cell phone, both used by the customers. The PC 20 and cell phone 21 are connected via networks to systems of banks and card companies, entities that issue cards through the networks. The networks are also connected to so-called teller terminals 22 installed at branches of the card issuers.

Denoted 30 and 70 are center systems of banks and card companies, the card issuers, and each of them includes an issuance information database 31 having an issuance state data table 31T containing issuance information and a key information database 32 having a key information data table 32T containing key information. The center systems also have an issuance acceptance program 41 to accept a card issuance request, a registration encryption key generation program 42 and a registration decryption key generation program 43 and execute processing according to these programs. Details of the processing will be described later. Each of the center systems has a storage media writing device 33 to write data into IC cards.

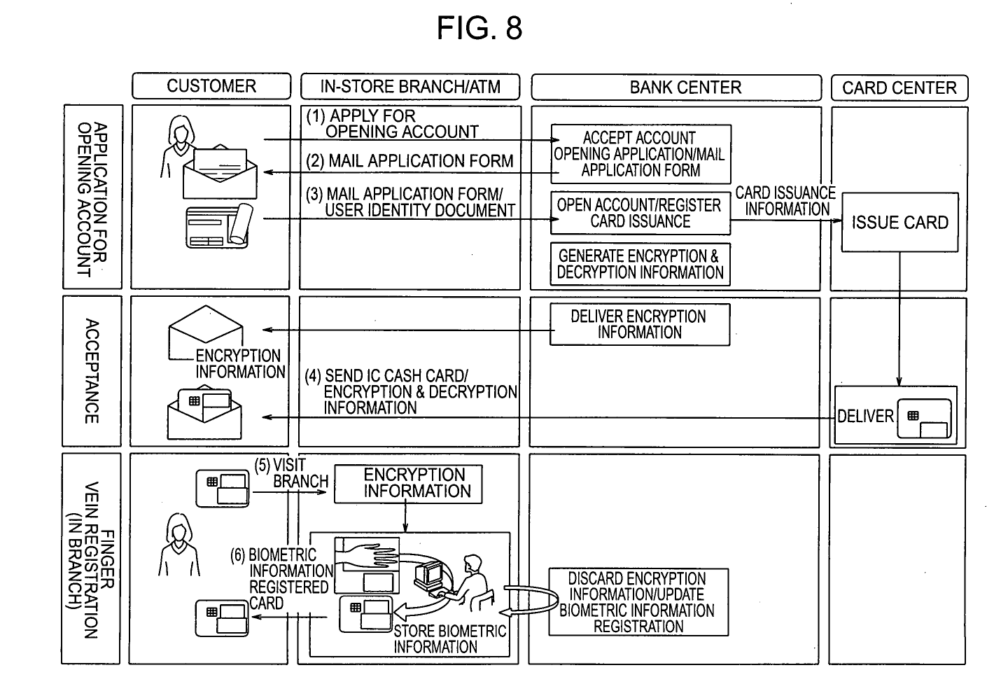

By referring to the accompanying drawings, the processing executed in this embodiment will be explained. First, the concept of this embodiment will be described by referring to FIG. 8. The card issuance center and the bank center may be identical in terms of organization (or device).

(1) A customer applies to a bank, the card issuer, for opening a bank account.

(2) The bank mails an application form to the customer.

(3) The customer mails the application and an applicant identity verification document to the bank center. As for the steps (1) to (3), step (2) and (3) may be omitted by electronically sending the application information through Internet at step (1) (this step is taken in this embodiment). The bank center generates encryption information to encipher biometric information and decryption information to decipher the encrypted information (to decipher the biometric information that was encrypted by the encryption information). The bank center sends the generated decryption information to the card center which stores the decryption information in an IC card.

(4) After the step (3), the card center mails a provisionally issued IC card (containing the decryption information) to the customer. The bank center sends the decryption information to the customer through other than the IC card mailing route. It may be sent through mail or email using the network.

(5) The customer carrying the mailed IC card comes to a branch office with an ATM capable of issuing a card.

(6) The ATM (in-store branch) (a) lets the customer put the IC card into a card insertion opening, (b) receives the encryption information that was sent to the customer, and (c) reads the biometric information of the customer. Then, the biometric information thus read in is encrypted by the ATM using the encryption information. In this case, the encryption processing may be executed in the IC card. Next, the ATM sends the encrypted biometric information into the IC card. The IC card decrypts the biometric information using the decryption information stored therein and then stores the decrypted biometric information in itself. The decryption processing may be executed by the ATM reading the decryption information from the IC card.

The biometric information that was successfully decrypted can be used as is. Those biometric information that failed to be decrypted cannot be used for biometric authentication. So, if the encrypted biometric information is stored without being decrypted, the issuance of the card can practically be prevented. Although in the above explanation, the decryption information is stored in the IC card, it may be stored in the ATM. In that case, the encryption processing may be executed in the IC card. Further, in this invention the encryption information includes other than an encryption key and the decryption information includes other than a decryption key.

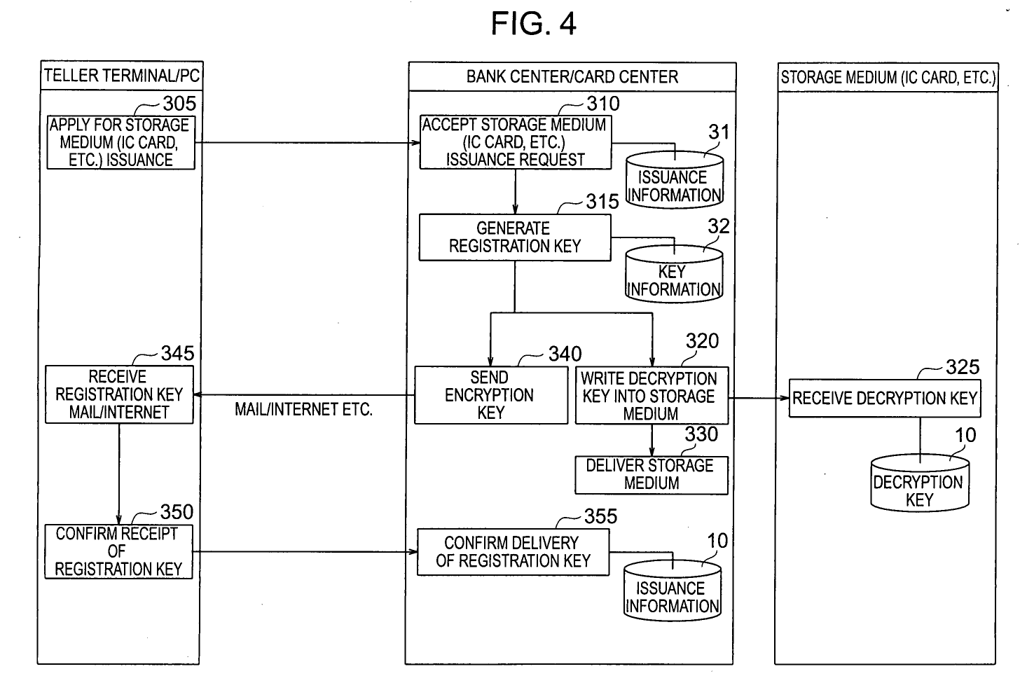

Next, by referring to FIG. 4 to FIG. 8, the information processing executed to implement the above steps (1) to (6) will be explained. First, the information processing (issuance preprocessing) associated with step (1) to (4) will be explained by referring to FIG. 4.

In step 305, in response to an input from a customer (or teller), the PC 20, cell phone 21 or teller terminal 22 applies to the bank center 30 or center 70 of the card company for issuance of an IC card 50. More specifically, the PC 20, cell phone 21 or teller terminal 22 sends issuance request information including name and address of the customer (or email address) to the bank system 30 through network.

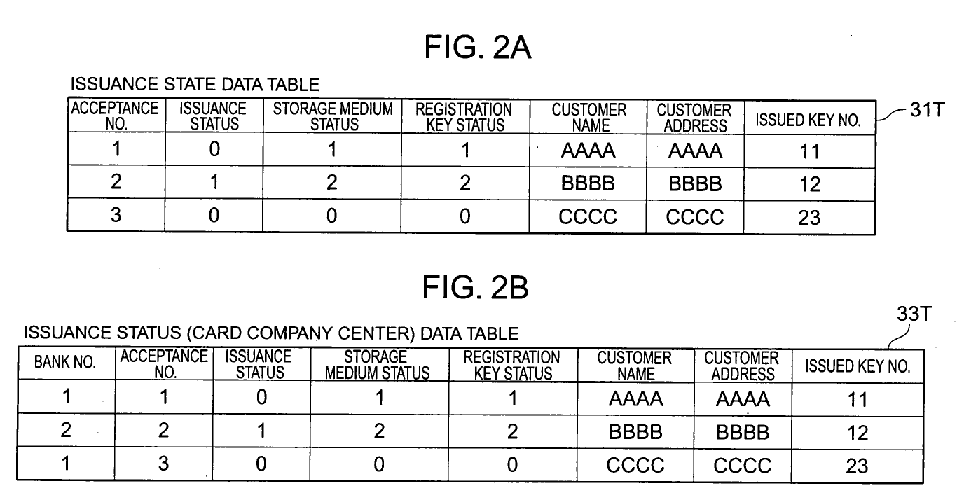

Next, in step 310 the bank system 30 accepts the issuance request. More specifically, the bank system 30 receives the issuance request information, matches the customer name and address contained in the issuance request information to an acceptance ID number, and stores them in an issuance state data table 31T of the issuance information database 31. The content of the table is shown in FIG. 2A and the requests are stored in the order of acceptance. At this stage, the issuance status, storage media status, registration key status and issued key No. are all given null (0).

Next, in step 315 the bank system 30 generates a registration key, key information required to register the biometric information with a storage medium. Here, an encryption key to encrypt the biometric information and a decryption key to decrypt the biometric information that was encrypted by the encryption key are generated. Although this embodiment uses “keys”, any other means may be used as long as it can perform a predetermined conversion on the subject information.

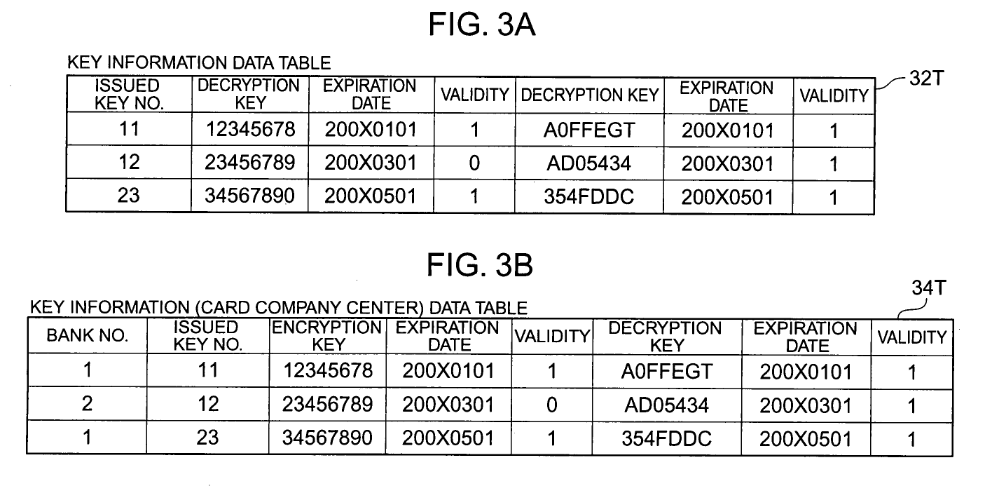

The generated registration keys (encryption key and decryption key) are matched to issued key numbers that identify the key information and then stored in the key information data table 32T of the key information database 32 (FIG. 3A). Here, in addition to the encryption key and the decryption key, their expiration date and validity are also stored. The expiration date is determined appropriately by the bank and the validity is set to “1” before the expiration date comes and “0” after it. The expiration date may be set to the same date for both the encryption key and the decryption key. In that case, rather than providing individual expiration dates, a record of one expiration date may be provided for each issued key No. The corresponding issued key No. is recorded in the issuance state data table 31T.

Next, in step 320, the bank system 30 records in the IC card 50 the decryption key generated by step 315 and the card No that identifies the card. When the writing is complete, the “issuance status” in the issuance state data table 31T is updated from 0 to 1, the “storage media status” from 0 to 1 and the “registration key status” from 0 to 1. These updates indicate that the decryption key has been recorded in the IC card. The card No. is also written into the issuance state data table 31T. The card No. may be an account number.

Then, in step 330, information processing is executed to mail this IC card. This information processing may involve printing the customer's address or prompting a bank staff with a displayed message to mail it. Then the “storage media status” in the issuance state data table 31T is updated from 1 to 2. This update indicates that the IC card has been dispatched. The IC card, rather than being sent to the customer, may be sent to a branch where the ATM 10 is installed, and handed to the customer from a bank staff.

In step 340 the bank system 30 executes information processing to send the generated encryption key to the customer. This processing includes either (1) sending the encryption key to the customer's PC 20 or cell phone 21 via email or (2) sending a media carrying the encryption key. The step (1) may involve recording the customer's email address in place of the customer's address in the issuance state data table 31T and sending the encryption key to the customer. The step (2) may involve printing the customer's address or prompting a bank staff with a displayed message to mail it. Then the “registration key status” in the issuance state data table 31T is updated from 1 to 2. This indicates that the encryption key has been dispatched to the customer.

Next, in step 345 the PC 20 (cell phone 21) receives the encryption key transmitted in step 340. If the encryption key is mailed, this device does not perform the step 345. Next, the PC 20 notifies the bank system 30 that it has received the encryption key. Then the bank system 30 receives this transmission from the PC and updates the corresponding “registration key status” in the issuance state data table 31T from 2 to 3 to indicate that the encryption key has been received by the customer.

If the issuance of the IC card is not performed by the bank itself but by an outsourced company, the processing will be as follows. The issuance request information received at step 310 and a bank No. that identifies the bank are transmitted from the bank system 30 to card company system 70. The card company system 70 generates an issuance status (card company center) data table 33T, such as shown in FIG. 2B. Compared with the issuance state data table 31T, this table 33T has an additional item of bank No. for bank identification. That is, the card company system 70 stores in the data table the bank No. identifying the source from which the issuance request information has been transmitted, in addition to the customers' names and addresses. Other parts of the processing are similar to what has been described above.

While in this embodiment the encryption key is sent to the customer and the decryption key is stored in the IC card, this may be reversed.

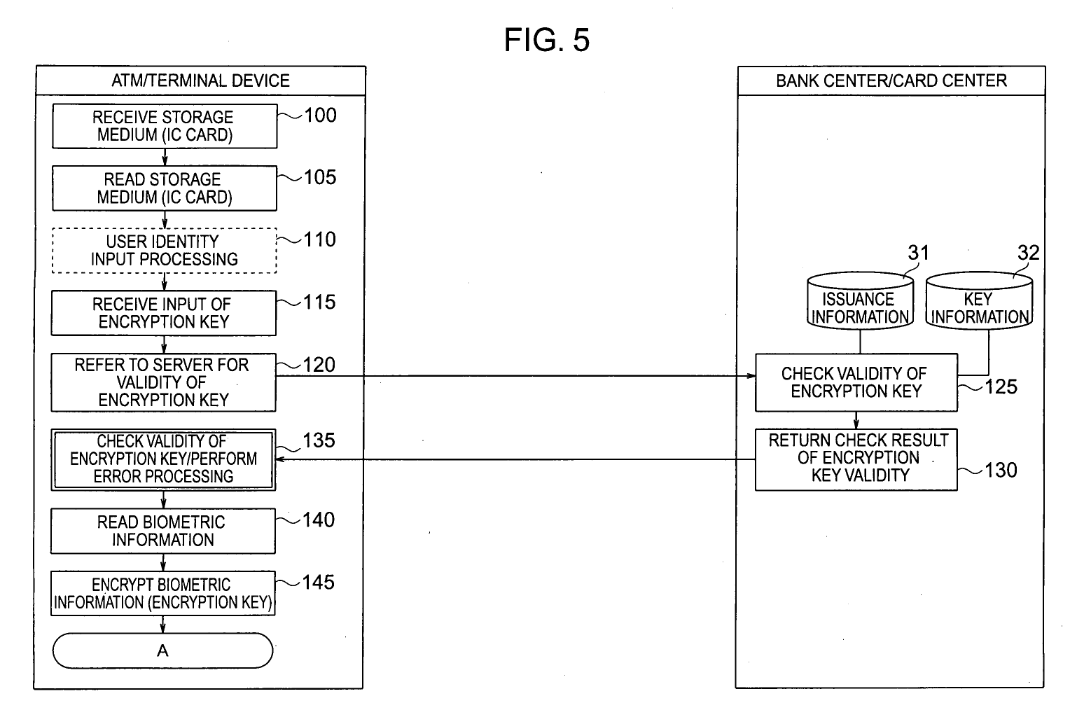

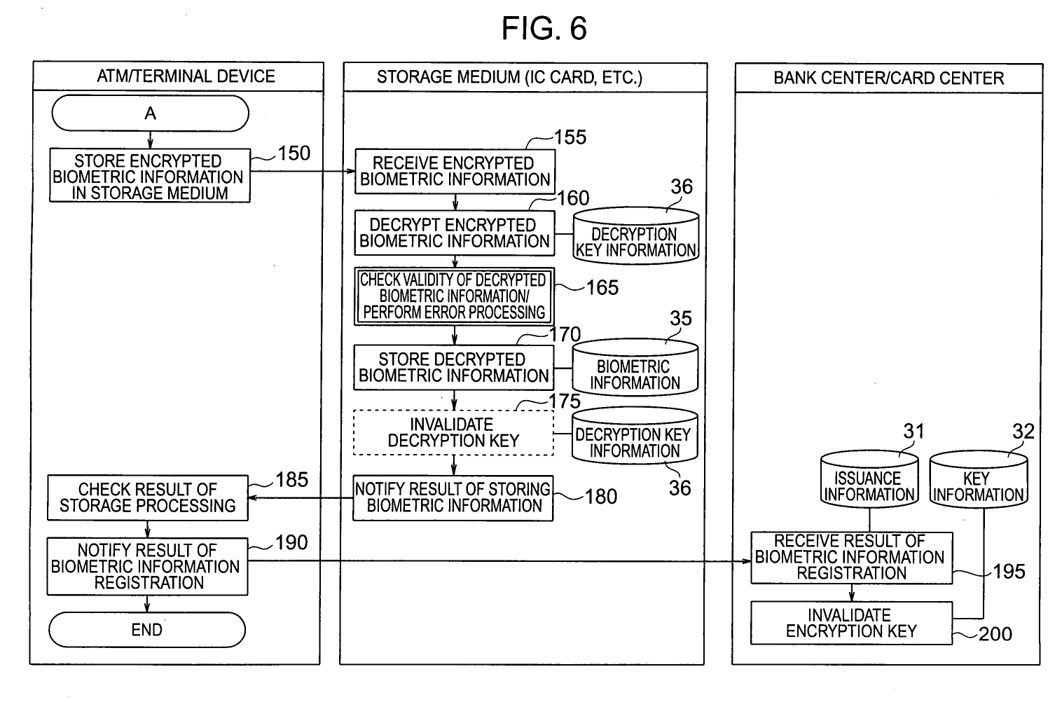

Next, by referring to FIG. 5 and FIG. 6, the issuance processing by the ATM (step (5) and (6) in FIG. 8) will be explained.

In step 100, the customer sets the IC card 50 in the storage media reading device 11. In step 105 the storage media reading device 11 reads the card No.

Then in step 110 the ATM 10 receives information from the customer necessary for personal identification. The information presented at this time includes a picture of his or her face taken by the terminal device and an ID card scanned by the terminal device, as well as fundamental information such as name and address. This step may be omitted.

Next, in step 115 the ATM 10 receives an input by the customer of the encryption key that was sent to the customer in step 340.

Next, in step 120 the ATM 10 sends to the bank system 30 (or the card company system 70) a request for validating the encryption key entered by the customer. The validity check request includes information to identify the encryption key. This identification information may be either the encryption key itself or the issued key No.

Next, in step 125 the bank system 30 (card company system 70) checks the validity check information against the key information data table 32T. If the validity has 1, it is decided that the encryption key is valid. Then at step 130 the bank system 30 (card company system 70) sends the result of step 125 to the ATM 10.

Next, in step 135 the ATM 10 performs processing according to the result of validity check received at step 130. If the encryption key is found to be invalid, error processing is initiated. The error processing includes a process of interrupting the registration processing and returning the storage media, and a process of skipping the registration processing and starts a transaction with a limited function. If the encryption key is found valid, the processing proceeds to step 140.

Next, in step 140 the ATM 10 issues a guidance, such as “put your finger in place”, to read biometric information (finger vein information) of the customer with a biometric information reading device 12. Then in step 145 the ATM 10 enciphers the finger vein information obtained at step 140 by using the encryption key entered at step 115.

Next, in step 150 the ATM 10 stores the encrypted data generated at step 145 in the IC card 50.

Next, in step 155 the IC card 50 accepts the encrypted data.

Then, in step 160 the encrypted data that was received at step 155 is decrypted by using the decryption key written in the IC card 50. The decryption key is one that was written at step 320. The decrypted biometric information is written into the memory area 35 in the IC card 50. The decrypted biometric information may be encrypted again before being stored in the memory area 35. The security can be enhanced if the encryption logic in this case uses other than the above encryption key (it is of course possible to use the same encryption key). As a result, the biometric information that comes out of the IC card during the authentication process is the encoded one, enhancing the security.

In step 165, the IC card 50 checks if the decryption is successfully completed. If the decryption is found to have failed, error processing is initiated. The error processing includes a process of notifying the decryption failure to the ATM 10 and ending the processing (processing moves to step 180), a process of shortening the expiration date for decryption in the IC card 50 in addition to the process described above, and a process of moving to the next step without performing the error processing. If it is decided that the decryption is successful, the processing moves to step 170.

In step 170, the IC card 50 stores the decrypted finger vein information in the card. In step 175 the IC card 50 invalidates the decryption key stored beforehand. This includes having the expiration date expire, invalidating a valid flag, or eliminating the key information itself. This processing is not necessary when the key information is managed by the server. In the process of making the expiration date expire, invalidation request information is sent to the bank system 30 (card company system 70) through the ATM 10 to change the validity in the key information table from 1 to 0. Here, the encryption key may also be invalidated.

In step 180, the IC card 50 notifies the result of biometric information storage processing to the ATM 10.

Next, in step 185 the IC card 50 checks the storage processing result notified by step 180. According to this result, if the storage processing is found to have failed, the storage media is returned. If it is successful, the processing moves to the next transaction screen. Then, in step 190 the ATM 10 transmits the result of biometric information registration processing to the bank system 30 (card company system 70).

In step 195, the bank system 30 (card company system 70) updates the issuance information database 31 according to the result notified from the ATM 10.

Finally in step 200, the bank system 30 (card company system 70) invalidates the encryption key. That is, the validity in the key information data table is changed from 1 to 0. The invalidation processing may invalidate the decryption key or the encryption key and decryption key.

In the issuance processing, omitting the step 120, 125, 130, step 190, 195 and step 200 can skip the linking with the-bank system 30 and the card company system 70, allowing the card issuance to be performed by only the ATM 10 and the IC card 50.

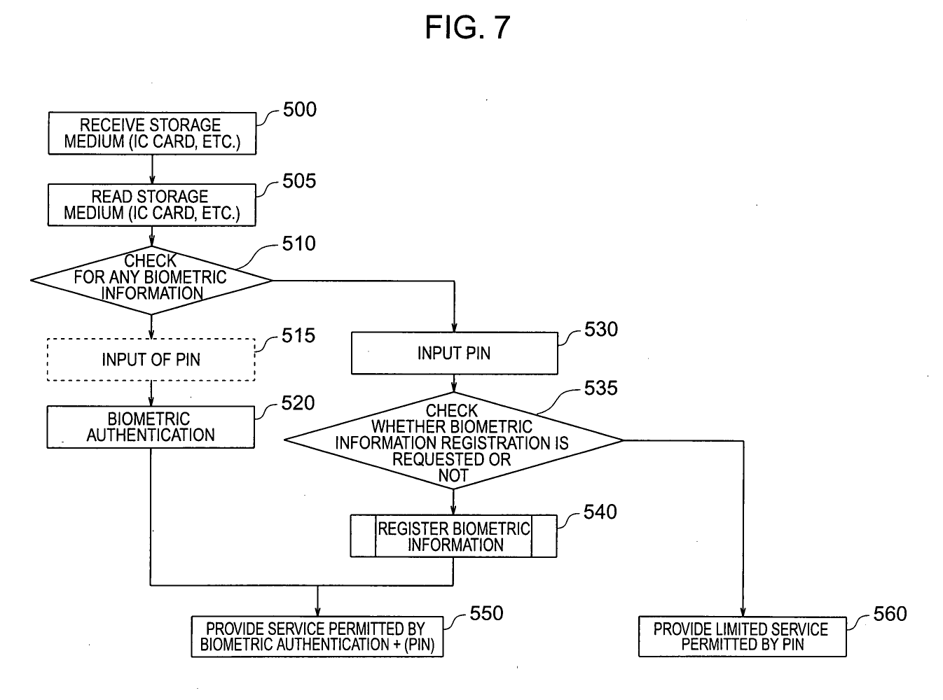

Next, by referring to FIG. 7, an authentication process performed when the issued IC card 50 is used (in transactions) will be explained.

First, in response to the input from the customer, the ATM 10 displays a transaction menu screen. When the customer specifies a transaction menu, a message is displayed prompting the customer to set the IC card 50 in the storage media reading device 11. At step 500 the customer sets the IC card 50 in the storage media reading device 11. Then at step 505 the ATM 10 reads the card No. from the IC card 50 through the storage media reading device 11.

Next, the ATM 10 at step 510 checks if finger vein information is already registered in the IC card. If vein information is not yet registered, the processing moves to step 530. If vein information is already registered, the processing moves to step 515. In step 510 a check may be made to see if encrypted finger vein information is stored in the IC card 50. If it is decided that encrypted finger vein information is stored, this situation is taken as an error and the card is drawn in.

In step 515 the ATM 10 in cooperation with the bank system 30 verifies the personal identification number entered by the customer. If the PIN number is verified, the processing moves to step 520.

At step 520 the ATM 10 checks the finger vein biometric information of the customer entered through the biometric information reading device 12 against the finger vein information stored in the IC card. This matching processing may be executed in the IC card 50. If the check decides that they agree, the processing moves to step 550 where information processing is executed to implement the transaction requested by the customer.

In step 530, the ATM 10 in cooperation with the bank system 30 verifies the personal identification number entered by the customer. If it is verified, processing moves to step 535 where the ATM 10 accepts an input from the customer requesting or omitting the registration of the finger vein information. If the registration procedure is not requested, the processing proceeds to step 560 which permits those transactions that are allowed under the PIN number authentication. If an input requesting the registration procedure is entered, the processing moves to step 540 where the above-described issuance processing is executed.

Then, in step 550 it is decided that the user identity is verified by both the biometric information and the PIN number (option) and transactions with no functional limitations (or those permitted only when both verifications are satisfied) are allowed.

It should be further understood by those skilled in the art that although the foregoing description has been made on embodiments of the invention, the invention is not limited thereto and various changes and modifications may be made without departing from the spirit of the invention and the scope of the appended claims.

1. A storage media issuing method to permit a storage medium to receive a predetermined service, comprising the steps of:
sending issuance request information from a user terminal to a storage media issuance management device, the user terminal being adapted to request the issuance of the storage medium;
receiving the request information by the storage media issuance management device and generating an encryption key for performing encryption according to the request information;
sending the encryption key from the storage media issuance management device to the user terminal, generating a decryption key corresponding to the encryption key and storing the decryption key in the storage medium;
allowing a user to set the storage medium containing the decryption key sent to the user in a reader/writer unit of an issuance terminal, the reader/writer unit being adapted to read and write information to and from the storage medium, the issuance terminal being adapted to issue the storage medium;
accepting by the issuance terminal an input of biometric information representing physical features of the user and of the encryption key;
encrypting the biometric information by the issuance terminal using the encryption key;
sending the encrypted biometric information from the issuance terminal to the storage medium set therein; and
decrypting the encrypted biometric information in the storage medium using the decryption key and storing the decrypted biometric information in the storage medium.

2. A storage media issuing method according to claim 1, wherein the storage medium, when the decryption of the biometric information fails, notifies the issuance terminal of the decryption failure;
wherein the issuance terminal, upon receiving the notification, collects the storage medium into the issuance terminal.

3. A storage media issuing method according to claim 1, wherein the storage medium, when the decryption of the biometric information succeeds, erases the decryption key stored in the storage medium.

4. A storage media issuing device to allow a storage medium to receive a predetermined service, comprising:
a biometric information reading unit to receive an input from a user of biometric information representing physical features of the user;
an input unit to receive an input from the user of an encryption key, the encryption key being adapted to encrypt specified information;
a storage media reading unit to read a decryption key stored in the storage medium, the decryption key being adapted to decrypt the encrypted information; and
a processing unit to encrypt the biometric information by using the encryption key and send the encrypted biometric information; and
wherein the encrypted biometric information is decrypted by using the decryption key and is stored in the storage medium to issue the storage medium.

5. A storage media issuing device according to claim 4, wherein the processing unit decrypts the encrypted biometric information by using the decryption key.

6. A storage media issuing device according to claim 4, wherein the processing unit, when the decryption of the biometric information fails, collects the storage medium into an issuance terminal.

7. A storage media issuing device according to claim 4, wherein the processing unit, when the decryption of the biometric information succeeds, erases the decryption key stored in the storage medium.

8. A storage media issuing device according to claim 4, wherein the storage medium is an IC card that can execute information processing,
the processing unit sends the encrypted biometric information to the IC card, and
the IC card decrypts the transmitted biometric information by using the decryption key.

9. A storage media issuing device according to claim 8, wherein when the decryption of the biometric information fails, the processing unit receives a notification from the IC card to an issuance terminal that the decryption has failed,
and, when it receives the notification, the processing unit issues an instruction to the issuance terminal to draw the IC card into the issuance terminal.

10. A storage media issuing device according to claim 8, wherein when the decryption of the biometric information succeeds, the IC card erases the decryption key stored in the IC card.

11. A biometric information registration method for registering with a storage medium biometric information of a user of the storage medium, the biometric information registration method comprising the steps of:
sending from a user terminal to a storage media management device request information requesting the registration of the biometric information;
receiving the request information at the storage media management device and generating by the storage media management device first and second paired information according to the request information, the first paired information being used to perform a conversion on information, the second paired information being used to perform a reverse conversion on the information that was converted by the first paired information;
controlling by the storage media management device to send the first paired information and the second paired information to the user through different routes;
receiving at a registration terminal the biometric information of the user, the first paired information and the second paired information entered by the user operation, the registration terminal being used to register the biometric information with the storage medium;
performing a conversion on the biometric information by the registration terminal according to the first paired information; and
performing a reverse conversion on the converted biometric information by using the second paired information and storing the reverse-converted biometric information in the storage medium.

12. A biometric information registration method according to claim 11, wherein the storage medium is an IC card capable of performing information processing,
the registration terminal sends to the IC card the biometric information which was subjected to decryption as one form of the conversion, and
the IC card decrypts the biometric information by using a decryption key in one form of the reverse conversion and stores the decrypted biometric information in itself.

13. A biometric information registration method according to claim 12, wherein when the decryption of the biometric information fails, the registration terminal receives a notification from the IC card that the decryption has failed,
and, when it receives the notification, the registration terminal issues an instruction to draw the IC card into an issuance terminal.

14. A biometric information registration method according to claim 12, wherein when the decryption of the biometric information succeeds, the IC card erases the decryption key stored in the IC card.
